(19) United States
(12) Patent Application Publication
(10) Pub. No.: US 2014/0319103 A1
(43) Pub. Date: Oct. 30, 2014

(54) WELDING ASSEMBLY FOR GAS SHIELDED ARC WELDING

(71) Applicant: Caterpillar Inc., PEORIA, IL (US)

(72) Inventors: JUSTIN DESHON STABB, VICTORIA, TX (US); CLAYTON MICHAEL ALEXANDER, VICTORIA, TX (US); NICKOLAS ISAAC GIBBS, VICTORIA, TX (US); GREGORY SCOTT SABO, VICTORIA, TX (US); CRAIG DAMON STAFF, VICTORIA, TX (US)

(21) Appl. No.: 14/324,097

(22) Filed: Jul. 4, 2014

(51) Int. Cl. B23K 9/32

(52) U.S. Cl. CPC B23K 9/325
USPC 219/74

(57) ABSTRACT

A welding assembly includes an adapter, a diffuser, and a nozzle. The adapter includes an inner portion, a discharge portion, and an engagement portion. The discharge portion defines an outer periphery and at least one aperture. The diffuser defines a contact end, a diffusion end and an outer periphery. The contact end is engaged with the discharge portion of the adapter. The nozzle includes a discharge end, an engagement, end and an inner surface. The engagement end defines a groove and engages with the engagement portion of the adapter. The groove and the outer periphery of the diffuser defines at least one discharge passage within the engagement end of the nozzle. The inner portion of the adapter is in fluid communication with the inner surface of the nozzle through the aperture the discharge passage. Shielding gas is directed toward tip portion of the contact tip through the discharge passages.

### TECHNICAL FIELD

The present disclosure relates generally to gas shielded arc welding. More specifically, the present disclosure relates to a welding assembly for performing gas shielded arc welding.

### BACKGROUND

Various processes are known in the welding industry to weld two or more workpieces. One such process is gas shielded arc welding. In this process, an electric arc is produced for melting a portion of the two workpieces at welding point. The gas shielded arc welding commonly includes welding assembly to feed weld wire towards the workpiece, contemporaneously with a shielding gas. The welding assembly provides the shielding gas to avoid reaction of the molten workpiece with the gases present in the external environment, thereby avoiding weld contamination. However, weld spatter, which typically acts to clog the welding assembly and restrict the flow of shielding gas, is a common problem associated with the gas shielded arc welding process.

Weld spatter may occur due to deposit of droplets of molten workpiece on various parts of the welding assembly. Over time, weld spatter may buildup inside nozzle of the welding assembly. In certain situations, weld spatter build up over the gas exit ports may cause an obstruction to the flow of the shielding gas. The obstruction to the flow of the shielding gas may result in the defective weld joints. Weld spatter may be cleared off by a reaming tool in conventional welding tip assemblies. The conventional welding tip assemblies, the gas exit ports are present in the diffuser. The diffuser may be bulky and may have intrinsic details, which makes it cumbersome for the reaming tool to clear off the spatter over the gas exit ports.

Further, the rate of weld spatter build up may be a function of various factors, such as welding temperature, type of flow of shielding gas, and/or the like. An increase in any of these factors may cause an increased amount of weld spatter. Hence, the gas exit ports may need servicing after short intervals. This may be inefficient.

### SUMMARY OF THE DISCLOSURE

One aspect of the present disclosure is directed to a welding assembly that directs shielding gas towards a workpiece during gas shield arc welding. The welding assembly includes an adapter that defines an inner portion, a discharge portion, and an engagement portion. The discharge portion has an outer periphery and at least one aperture defined therein. The welding assembly includes a diffuser that defines a contact end, a diffusion end, and an outer periphery, while having the contact end engaged with the discharge portion of the adapter. Further, a nozzle defines an engagement end, a discharge end, and an inner surface between the engagement end and the discharge end. The engagement end of the nozzle is adapted to engage the engagement portion of the adapter. Moreover, the engagement end of the nozzle defines a groove, at least one discharge passage is defined by the outer periphery of the diffuser, and the groove within the engagement end of the nozzle. Here, the inner portion of the adapter is in fluid communication with the inner surface of the nozzle through the at least one discharge passage. Additionally, the shielding gas is directed inside the nozzle through the at least one discharge passage.

Another aspect of the present disclosure is directed to a welding assembly that directs shielding gas towards a workpiece to be gas shield arc welded. The welding assembly includes an adapter defining an inner portion, a discharge portion, and an engagement portion. The discharge portion defines an outer periphery and at least one aperture. The welding assembly includes a diffuser to define a contact end, a diffusion end, and an outer periphery. The contact end is engaged with the discharge portion of the adapter. Further, a contact tip having a base portion and a tip portion is also included. Additionally, a nozzle defining an engagement end, a discharge end, and an inner surface, defined between the engagement end and the discharge end is included as well. The engagement end of the nozzle is adapted to engage the engagement portion of the adapter, and retain the base portion of the contact tip. Moreover, the engagement end of the nozzle defines a groove therein. At least one discharge passage is defined by the outer periphery of the diffuser and the groove within the engagement end of the nozzle. Here, the inner portion of the adapter is in fluid communication with the inner surface of the nozzle through the at least one discharge passage. The shielding gas is directed toward the tip portion of the contact tip through the discharge passages.

### BRIEF DESCRIPTION OF DRAWINGS

FIG. 1 illustrates an exploded view of an exemplary welding assembly, for gas shielded arc welding in accordance with the concepts of the present disclosure;

FIG. 2 illustrates a sectional view of the welding assembly of FIG. 1 in accordance with a first embodiment of the present disclosure;

FIG. 3 illustrates a perspective sectional view of the welding assembly of FIG. 2 with the contact tip removed to better show the flow of inert gas flow depicted by arrows; and

FIG. 4 illustrates a perspective sectional view of the welding assembly of FIG. 1 in accordance with a second embodiment of the present disclosure wherein the contact tip is removed to better show the flow of inert gas flow depicted by arrows.

### DETAILED DESCRIPTION OF DRAWINGS

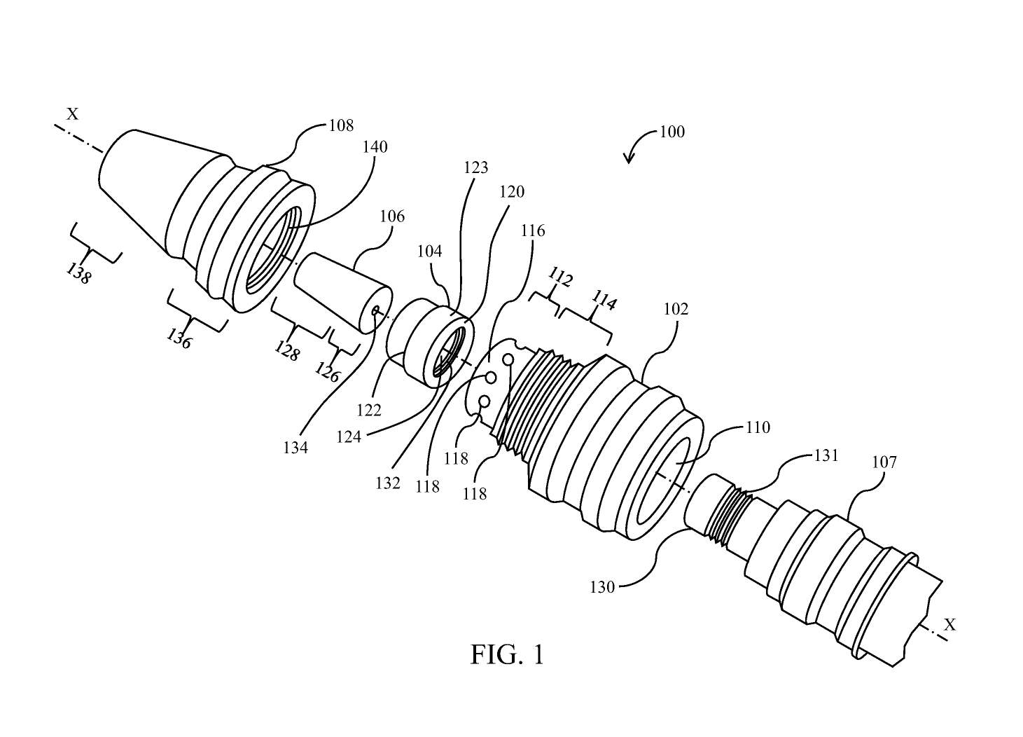

Referring to FIG. 1, shown is a welding assembly 100 for performing gas shielded arc welding. The welding assembly 100 may include an adapter 102, a diffuser 104, a torch neck 107, and a nozzle 108 for the directing of a gas toward a contact tip 106 as will be explained below.

The adapter 102 is a substantially hollow cylinder with which a shielding gas supply may be connected. The adapter 102 defines an inner portion 110 of the hollow cylinder, a discharge portion 112, and an engagement portion 114. The discharge portion 112 includes an outer periphery 116 and at least one aperture 118 through which the shielding gas exits the adapter 102. The engagement portion 114 of the adapter 102 has external threads and may be in threaded engagement with the nozzle 108.

The diffuser 104 defines a contact end 120, a diffusion end 122, an outer periphery 123 and an engagement surface 124. The contact end 120 abuts with the discharge portion 112 of the adapter 102. The diffuser 104 provides electrical insulation between the contact tip 106 and the nozzle 108. The engagement surface 124 of the diffuser 104 is in threaded engagement with a contact tip retention tube 130 of the torch neck 107. The contact tip retention tube 130 includes external threads 131 which mesh with internal threads 132 of the engagement surface 124 of the diffuser 104. In an embodiment, the engagement surface 124 of the diffuser 104 may be in threaded engagement with the contact tip 106.

The contact tip 106 includes a base portion 126 and a tip portion 128. The base portion 126 of the contact tip 106 is retained inside the contact tip retention tube 130 of the torch neck 107. The base portion 126 of the contact tip 106 may be retained inside the contact tip retention tube 130 by a threaded engagement, a press fit engagement, or any equivalent thereof.

The contact tip 106 produces the electric arc required for melting the two workpieces. The contact tip 106 may be a conductive metal, such as but not limited to, copper, silver, and/or the like. The contact tip 106 of the welding assembly 100 conducts an electric current to the consumable weld wire (not shown). The weld wire is guided by a guide passage 134 formed in the contact tip 106. The contact tip 106, which is conductive in nature, transfers the welding current to the consumable weld wire (not shown). Therefore, the welding wire produces an electric arc with the workpiece when it contacts the workpiece which in turn creates a welded joint between the workpieces fused by the molten wire as is customary.

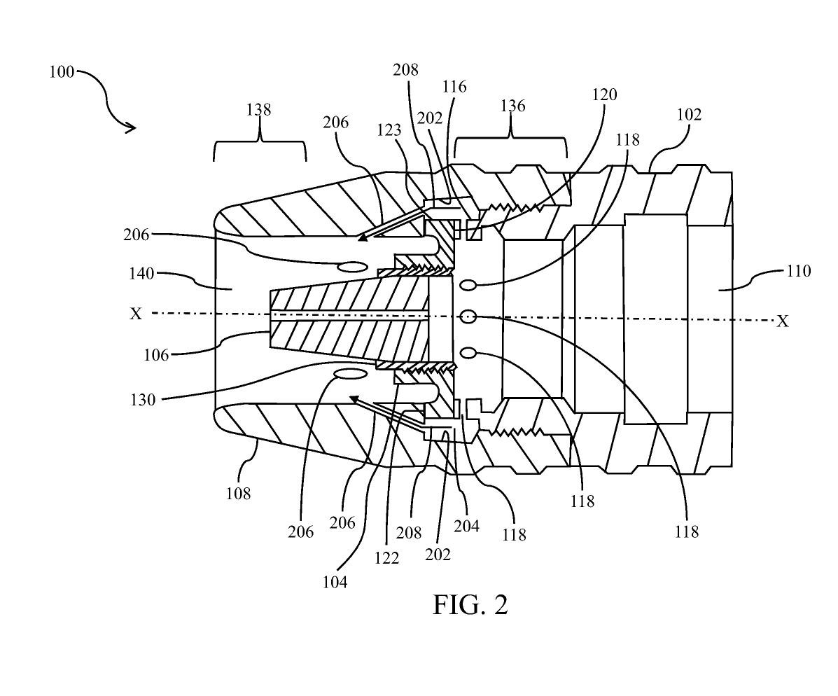

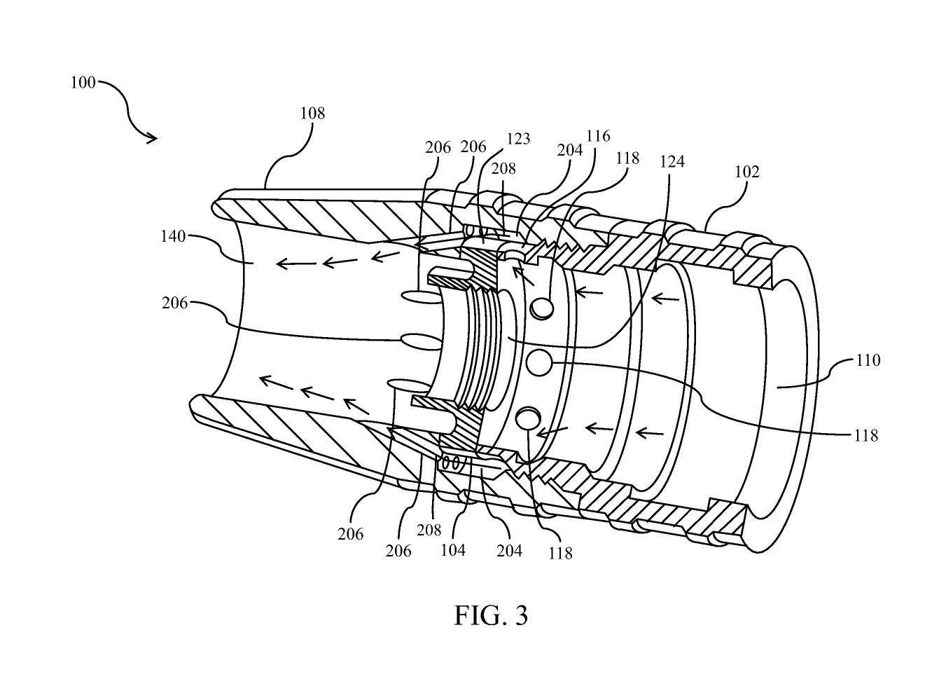

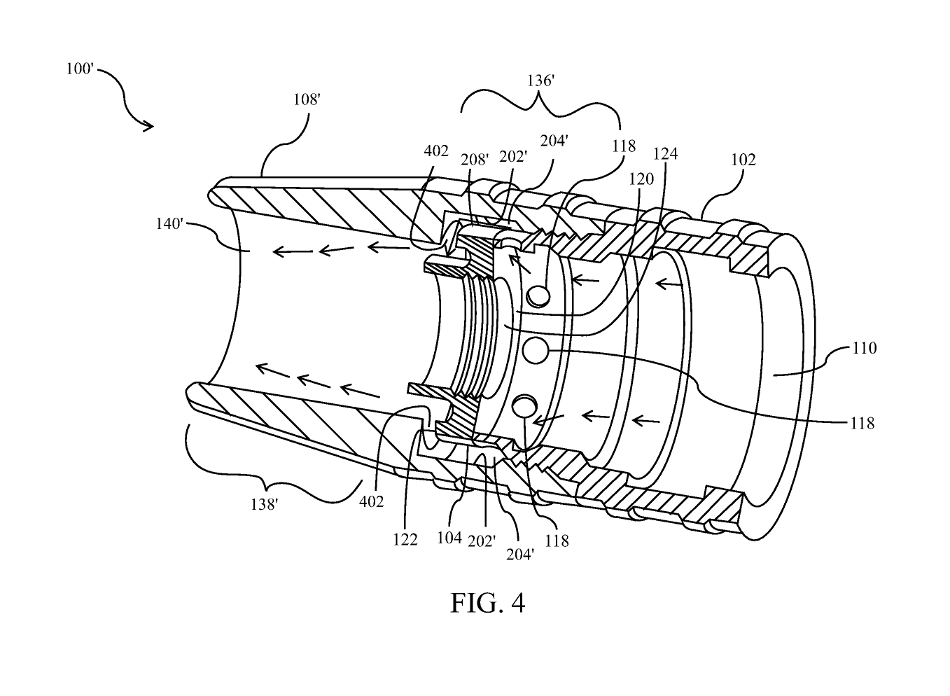

Further, the diffuser 104 and the contact tip 106 are retained inside the nozzle 108. The nozzle 108 includes an engagement end 136, a discharge end 138, and an inner surface 140 therebetween. The engagement end 136 of the nozzle 108 is in threaded engagement with the engagement portion 114 of the adapter 102. Furthermore, the details of the nozzle 108 and the welding assembly 100 are shown and discussed in conjunction with FIG. 2, FIG. 3, and FIG. 4.

Referring to FIG. 2, shown is a sectional view of the welding assembly 100 in accordance with a first embodiment of the present disclosure. The nozzle 108 of the welding assembly 100 covers the diffuser 104 and the contact tip 106. The engagement end 136 of the nozzle 108 includes a groove 202 therein. When the nozzle 108 is assembled with the adapter 102 and the diffuser 104, a chamber 204 is formed between the groove 202 and the outer periphery 116 of the discharge portion 112 of the adapter 102 and the outer periphery 123 of the diffuser 104 inside the engagement end 136. In this embodiment, the diffusion end 122 abuts the groove 202. Also, the nozzle 108 includes a plurality of inclined holes 206, which extend between the groove 202 and the inner surface 140 of the nozzle 108. Each of the inclined holes 206 are inclined at an angle to a nozzle axis X-X. The chamber 204 and each of the inclined holes 206 together define at least one discharge passage 208, enabling the shielding gas to flow towards the tip portion 128 of the contact tip 106.

Referring to FIG. 3, shown is a flow of the shielding gas, the flow being illustrated by arrows, through the welding assembly 100 with the contact tip 106 removed to better show the flow of shielding gas, in accordance with the first embodiment of the present disclosure. The shielding gas flows from the inner portion 110 of the adapter 102 to the chamber 204 through each of the apertures 118, and in turn, from the chamber 204 to the discharge end 138 of the nozzle 108 through each of the inclined holes 206. Thereby, each of the discharge passage 208 is structured and arranged to generally direct, the shielding gas radially and axially inward, in a direction towards the tip portion 128 of the contact tip 106. Hence, the shielding gas flows to the weld area and protects the molten workpiece from reacting with the external environment.

Referring to FIG. 4, shown is a second embodiment of a welding assembly 100′. The differences in welding assembly 100′ (shown in FIG. 4) relative to the welding assembly 100 (shown in FIGS. 1-3) will now be explained.

In this embodiment, the welding assembly 100′ include a nozzle 108′, which is substantially similar to the nozzle 108 shown in FIGS. 2-3, but, without having the inclined holes 206. Hence, a discharge passage 208′ in the welding assembly 100′ is defined differently as discussed below.

When the nozzle 108′ is assembled with the diffuser 104 and the adapter 102, a chamber 204′ is formed similar to the one shown and explained with reference to FIG. 2. In this embodiment, however, the diffusion end 122 of the diffuser 104 does not abut the nozzle 108′. Rather, the diffusion end 122 assembles within the nozzle 108′ in a manner where it stops before an abutment. Therefore, the diffuser 104 is assembled with the adaptor 102 and within the nozzle 108′ such that a peripheral gap 402 is formed between the groove 202′ and the diffusion end 122 of the diffuser 104. The chamber 204′ and the peripheral gap 402 define the discharge passage 208′. The discharge passage 208′ enables the shielding gas to flow towards the tip portion 128 of the contact tip 106. Also, the diffusion end 122 is castled to facilitate retention of the diffuser 104 within the nozzle 108′, while enabling flow of shielding gas towards the contact tip 106. In effect, a configuration having at least one discharge passage 208′ now adopts a single passage defined by the peripheral gap 402 existing between the nozzle 108′ and the diffuser 104.

Again referring to FIG. 4, shown is a flow of the shielding gas, the flow being illustrated by arrows, through the welding assembly 100′. The shielding gas flows from the inner portion 110 of the adapter 102 to the chamber 204′ through each of the apertures 118, and in turn, from the chamber 204′ to a discharge end 138′ of the nozzle 108′ through the peripheral gap 402. Therefore, the discharge passage 208′ direct the shielding gas inwardly, towards the tip portion 128 of the contact tip 106. Hence, the shielding gas flows to the weld area and protects the molten workpiece from reacting with the external environment.

### INDUSTRIAL APPLICABILITY

The welding assemblies 100, 100′, as described in the present disclosure, may be attached to shielding gas supply proximal to the engagement portion 114 of the adapter 102. The shielding gas supply may be provided through a conduit to supply a controlled amount of shielding gas to the adapter 102. Further, the contact tip 106 is connected to an electric polarity and the workpiece is given opposite polarity for producing the electric arc.

In operation, as the welding assemblies 100, 100′ is brought near the workpiece, the contact tip 106 produces the electric arc between the welding wire and the workpiece. The heat produced by the electric arc melts portions of the workpiece contemporaneously with the weld wire. At the same time, the shielding gas is supplied to the weld joint to protect the weld from reacting with the external environment. The shielding gas supply is directed to inner portion 110 of the adapter 102 respectively shown in FIGS. 3, 4).

Referring to FIG. 3, specifically regarding welding assembly 100, the shielding gas flows from the inner portion 110 of the adapter 102, to the chamber 204, through each of the apertures 118. Further, the shielding gas flows from the chamber 204, to the discharge end 138 of the nozzle 108, through each of the inclined holes 206. The inclined holes 206 are arranged at an angle corresponding to the nozzle axis X-X. Therefore, and therefore, each of the discharge passage 208 directs the shielding gas inwards towards the contact tip 106.

Referring now to FIG. 4, the welding assembly 100′ directs the shielding gas flow through the discharge passage 208′ formed by the groove 202′ of the nozzle 108′, adapter 102, and the diffuser 104, and, as a result, the shielding gas flow is directed through this ring shaped passage and thereafter toward contact tip 106.

The flow of the shielding gas, as explained in the present disclosure, provides a smooth flow of the shielding gas towards the area of weld joint. The smooth flow of shielding gas through the welding assemblies 100, 100′ may generate a minimum amount of weld spatter as the amount of weld spatter may depend on the flow characteristics of the shielding gas. Also, during welding, a relatively increased distance between the contact tip 106 and the workpiece may be achieved due to improved flow characteristics of the shielding gas.

Further, it may be seen that over a period of operation the welding assemblies 100, 100′, experience weld spatter being accumulated inside the nozzle 108, 108′. However, since the welding assemblies 100, 100′ have a construct to direct the flow of shielding gas through radial outer portions of the adapter 102 and the diffuser 104, this construct aids significantly in increased space within the inner portion of the nozzle 108,108′ resulting in expanded room for the use of a reaming tool into the nozzle 108, 108′. In an embodiment, the reaming tool may be a hollow cylindrical tool having teeth along the circumference of the reaming tool. The reaming tool may be inserted inside the nozzle 108, 108′ through the discharge end 138, 138′ of the nozzle 108, 108′. The reaming tool may rotate inside the nozzle 108, 108′ to clear off splatter produced along the inner surface 140, 140′ of the nozzle 108, 108′ and an outer surface of the diffuser 104. Further, the reaming tool may act on the weld spatter accumulated on the discharge passages 208, 208′. As the reaming tool rotates inside the inner surface 140, 140′ of the nozzle 108, 108′, the weld spatter accumulated on the discharge passages 208, 208′ is machined off to return the inner diameter of the nozzle 108, 108′ back to operable condition. Any broken weld splatter, during the reaming operation, can be removed from the discharge passages 208, 208′ by blowing air from the adapter 102 to the discharge passages 208, 208′. Hence, the weld spatter produced by the welding assemblies 100, 100′ is easily cleared off by the reaming tool, even without removing the contact tip 106. This reduces the cleaning time of the welding assembly 100, 100′, thereby improving efficiency in the gas shielded arc welding process.

What is claimed is:

1. A welding assembly to direct shielding gas towards a workpiece, to be gas shield arc welded, the welding assembly comprising:
an adapter defining an inner portion, a discharge portion and an engagement portion, the discharge portion defining an outer periphery and at least one aperture defined in the discharge portion;
a diffuser defining a contact end, a diffusion end and an outer periphery, the contact end being engaged with the discharge portion of the adapter;
a nozzle defining an engagement end, a discharge end and an inner surface therebetween, the engagement end of the nozzle being adapted to engage the engagement portion of the adapter, the engagement end of the nozzle defining a groove therein, at least one discharge passage being defined by the outer periphery of the diffuser and the groove within the engagement end of the nozzle,
wherein the inner portion of the adapter is in fluid communication with the inner surface of the nozzle through the at least one discharge passage and shielding gas being directed inside the nozzle through the at least one discharge passage.

2. A welding assembly to direct shielding gas towards a workpiece, to be gas shield arc welded, the welding assembly comprising:
an adapter defining an inner portion, a discharge portion and an engagement portion, the discharge portion defining an outer periphery and at least one aperture defined in the discharge portion;
a diffuser defining a contact end, a diffusion end and an outer periphery, the contact end being engaged with the discharge portion of the adapter;
a contact tip having a base portion and a tip portion;
a nozzle defining an engagement end, a discharge end and an inner surface therebetween, the engagement end of the nozzle being adapted to engage the engagement portion of the adapter and retain the base portion of the contact tip, the engagement end of the nozzle defining a groove therein, at least one discharge passage being defined by the outer periphery of the diffuser and the groove within the engagement end of the nozzle,
wherein the inner portion of the adapter is in fluid communication with the inner surface of the nozzle through the at least one discharge passage and shielding gas being directed toward the tip portion of the contact tip through the discharge passages.
